(19) United States
(12) Patent Application Publication
(10) Pub. No.: US 2005/0107272 A1
(43) Pub. Date: May 19, 2005

(54) Topical aqueous cleansing composition

(75) Inventors: Claudia Pinzon, New Milford, NJ (US); Laura Schick, Newburgh, NY (US); Walter J. Carmody, Port Jervis, NY (US)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Avon Products, Inc.

(21) Appl. No.: 10/722,878

(22) Filed: Nov. 26, 2003

Related U.S. Application Data
(60) Provisional application No. 60/519,893, filed on Nov. 14, 2003.

(51) Int. Cl. C11D 1/00

(52) U.S. Cl. 510/130

(57) ABSTRACT

There is provided a topical aqueous cleansing composition. The composition has about 0.05 wt % to about 20 wt % of one or more waxes having a melting point of about 70° C. or more, an anionic surfactant and an additional surfactant selected from the group consisting of a nonionic surfactant, an amphoteric surfactant, and a combination of a nonionic surfactant and an amphoteric surfactant in an amount effective to stabilize the wax in the composition, and about 20 wt % or more water. There is also provided a method for cleansing and/or moisturizing a keratinous surface.

### BACKGROUND OF THE INVENTION

1. Field of the Invention

The present invention relates to a topical aqueous cleansing composition that provides gentle, effective cleaning while leaving the washed area with desirable benefits, such as with smooth, soft, silky and moisturized skin.

2. Description of the Prior Art

Personal care and cosmetic compositions are frequently formulated by the industry to be thick, rich, smooth and creamy. Such compositions may contain ingredients to treat, condition, or impart desired properties to the skin, nail or hair. Such ingredients may include one or more fatty acids, fatty alcohols, oils, silicones, cationic polymers and surfactants, waxes, or combinations thereof. Some ingredients, such as fatty alcohols and acids, may be selected so as to have a melting point at or near that of the surface of the body. Ingredients may also be incorporated to improve the overall aesthetics of the composition.

Cleansing compositions are formulated to remove accumulated cellular debris, dirt, oil, or environmental pollutants from the skin, nail and hair. Strong surfactants, such as anionic surfactants, provide excellent cleansing performance but can cause irritation and can remove essential oils from the skin and hair. Milder surfactants, such as nonionic surfactants, can be gentle, cause little or no irritation and preserve essential oils but provide lower cleaning performance. Poor cleansing leaves behind unwanted material, which tends to build up and leaves surfaces dull and greasy.

It would be desirable to have a topical cleansing composition that provides effective cleansing performance yet is gentle and non-irritating. It would further be desirable to have a topical cleansing composition that prevents the loss of essential skin oils or deposited a protective layer to permit replenishment of such oils.

### SUMMARY OF THE INVENTION

It is an object of the present invention to provide a topical aqueous cleansing composition.

It is a further object of the present invention to provide a topical aqueous cleansing composition that is gentle and non-irritating.

According to these and other objects of the invention, there is provided a composition having the following: a) about 0.05 wt % to about 20 wt % of one or more waxes having a melting point of about 70° C. or more; b) an anionic surfactant surfactant and an additional surfactant selected from the group consisting of a nonionic surfactant, an amphoteric surfactant, and a combination of a nonionic surfactant and an amphoteric surfactant, in an amount effective to stabilize the wax in the composition; and c) about 20 wt % or more of water.

According to these and other objects of the invention, there is provided a method for cleansing a keratinous surface, such as skin, hair and nails. The composition is applied to the surface thereof and the surface then rinsed/washed.

### DETAILED DESCRIPTION OF THE INVENTION

It has been surprisingly found that a cleansing composition could be formulated to provide gentle, effective cleaning yet provide for protection and/or replenishment of essential skin oils. It has also been further surprisingly found that such a composition could be formulated with a high melting point wax.

The high melting point wax is dispersed, solubilized or dissolved in the present composition. The wax protects essential oil content in the skin or hair by reducing the amount washed or rinsed away and by providing a protective layer that conditions and moisturizes while facilitating the replenishment of such content. The wax has a high degree of hardness, which enhances the wash resistance and integrity of the formed protective layer. The wax also functions to thicken or viscosify the composition. In certain embodiments of the present invention, the composition provides a rich, creamy feel and aesthetic appearance. The wax performs multiple functions in the composition enabling some ingredients to be replaced or eliminated, if desired.

The high melting point wax useful in the composition of the present invention has a melting point of about 70° C. or more. A preferred melting point is about 80° C. to about 100° C. A most preferred melting point is about 85° C. to about 90° C. The wax preferably has a hardness of 4 or more. A more preferred hardness is about 4 to about 14. A most preferred hardness is about 4 to about 6 as measured by a penetrometer.

The wax may be selected from any natural or synthetic wax having the required melting point and/or hardness. Suitable natural waxes include, but are not limited to, animal waxes, plant waxes, mineral waxes and petroleum waxes. Suitable synthetic waxes include, but are not limited to, polymeric waxes and hydrocarbon waxes. Suitable waxes include, but are not limited to, the following: castor wax, candelilla wax, carnauba wax, jojoba wax, beeswax, ozokerite, lanolin wax, montan wax, paraffin, palm kernel wax, ceresin, silicone waxes and cetyl esters. Additional waxes are disclosed in the International Cosmetic Ingredient Dictionary and Handbook, 9^{th} ed., vol. 4, p.

2875. Preferred waxes are hydrogenated waxes having an average iodine point of about 40 or less. A most preferred hydrogenated wax has an average iodine point of about 5 or less.

The wax is preferably present in the present composition at from about 0.05 to about 20 wt % (weight percent) based on the total weight of the composition. More preferably, the wax is about 0.4 to about 10 wt %. Most preferably, the wax is about 1 to about 5 wt %. A most preferred composition has about 4.0 wt % wax.

The present composition is aqueous. The composition has about 20 wt % or more water. Preferred compositions have about 20 wt % to about 90 wt % water. More preferred compositions have about 40 wt % to about 80 wt % water. Most preferred compositions have about 60 wt % to about 80 wt % water.

The surfactant system functions to stabilize the wax in the composition and provide a topical cleansing effect. Useful surfactants include anionic, nonionic and amphoteric surfactants. The surfactant system has an anionic surfactant surfactant and an additional surfactant selected from the group consisting of a nonionic surfactant, an amphoteric surfactant, and a combination of a nonionic surfactant and an amphoteric surfactant. The surfactants of the system are present in an amount effective to stabilize the wax in the composition. Generally, surfactants will be present at up to about 70 wt %, preferably about 5 wt % to about 60 wt %, and most preferably about 30 wt % to about 55 wt % based on the total weight of the composition. A preferred surfactant system has about 5 to about 50 wt % of one or more anionic surfactants. A preferred surfactant system has about 1 to about 15 wt % of one or more nonionic surfactants. A preferred surfactant system has about 1 to about 40 wt % of one or more amphoteric surfactants. A more preferred surfactant system in the present composition has one or more of about 15 to about 30 wt % of one or more anionic surfactants, about 5 to about 10 wt % of one or more nonionic surfactants, and about 5 to about 15 wt % of one or more amphoteric surfactants. A most preferred surfactant system has all three types of surfactants.

Anionic surfactants include those surfactants in which the charge on the hydrophobe is negative. Anionic surfactants offer high foaming/lathering characteristics and high cleansing efficacy. Useful anionic surfactants include, but are not limited to, salts of acylamino acids, salts of carboxylic acids, salts of phosphoric acids, salts of sulfonic acids, and sulfuric acid esters. Examples of useful anionic surfactants are sulfosuccinates, sarcosinates, alpha-olefin sulfonates, sarcosines and fatty alcohol sulfates. Additional anionic surfactants are disclosed in the International Cosmetic Ingredient Dictionary and Handbook, 9^{th} ed., vol. 4, p. 2955-2962, which is incorporated herein by reference. A preferred anionic surfactant is sodium laureth sulfate.

Nonionic surfactants include those that are surface active but carry no charge. Nonionic surfactants may have levels of ethoxylation or propoxylation. Useful non-ionic surfactants include those of the following: alcohols, alkanolamides, amine oxides, esters, and ethers. Examples of useful nonionic surfactants are sorbitan derivatives, fatty alcohol ethoxylates, fatty acid monoisopropanolamides, polyethylene glycol and fatty acid monoethanolamides. Additional nonionic surfactants are disclosed in the International Cosmetic Ingredient Dictionary and Handbook, 9^{th} ed., vol. 4, p. 2955-2962, which is incorporated herein by reference. Preferred nonionic surfactants include lauramide monoethanolamide, cocamide monoethanolamide and cocamide monoisopropylamine (MPA).

Amphoteric surfactants include those having a charge on the hydrophobe that changes as a function of the pH. Amphoteric surfactants carry a positive charge in strongly acidic media and a negative charge in strongly basic media. Amphoteric surfactants carry no charge, or are zwitterionic, at intermediate pH. Useful amphoteric surfactants include acyl/diallyl ethylenediamines and derivatives and N-Allyamino acids. Additional amphoteric surfactants are disclosed in the International Cosmetic Ingredient Dictionary and Handbook, 9^{th} ed., vol. 4, p. 2955-2962, which is incorporated herein by reference. A preferred amphoteric surfactant is cocamidopropyl betaine.

The present composition may take on a variety of product forms such as a cream, lotion, foam, pump liquid, pump spray, aerosol spray, mousse, pomade, mask, solution, towelette or stick/solid. The present composition preferably takes the form of a fluid or liquid such that it can be poured, squeezed, sprayed or pumped from a dispensing container. The composition most preferably is in a product form other than a stick or solid.

Consistent with the preferred fluid or liquid form, the present composition exhibits a viscosity of preferably about 1000 to about 40,000 cps, more preferably about 10,000 to about 40,000 cps, and most preferably about 10,000 to about 30,000 cps. The wax can function to provide the desired viscosity levels, although thickeners and viscosifiers may optionally be added to the composition to further adjust such viscosity levels. Suitable thickeners include, but are not limited to, natural and synthetic polymers, gums and clays. Polymers include, but are not limited to, cellulose and cellulose derivatives, acrylic acid/acrylate polymers and copolymers. Gums include, but are not limited to, guar, locust bean, chitosan, agar, algin, galactomannan, xanthan, and carrageenan. Clays include, but are not limited to, attapulgite, hectorite, bentonite and kaolin.

The present composition can take the form of a dispersion or an emulsion. The wax can be dispersed, solubilized or dissolved in the oil phase of the emulsion. Suitable emulsions include water-in-oil, oil-in-water, water-in-silicone, silicone-in-water and triple emulsions. When the present composition is an emulsion, it may contain one or more emulsifiers to provide a homogeneous dispersion of the discontinuous phase in the continuous phase. Emulsifiers include, but are not limited to, the anionic, nonionic, and amphoteric surfactants described above, such as sodium laureth sulfate, cocamide monoethanolamide and cocamidopropyl betaine. Other emulsifiers are shown, by way of example, in U.S. Pat. No. 5,244,665 (Table 1), which is incorporated herein by reference. Emulsions may have oil-phase vehicles, such as vegetable oils, fatty acid esters, fatty acid alcohols, isoparaffins, silicone oils, hydrocarbon oils, and combinations thereof. Emulsions may have aqueous-phase vehicles in addition to water, such as glycerin, propylene glycol, pentylene glycol, ethylene glycol, hexylene glycol, and combinations thereof.

Compositions of the present invention may be prepared according to any method known in the art. For example, emulsion compositions may be prepared as follows: a) water-soluble and/or water-miscible ingredients are mixed with water at ambient or elevated temperatures to form an aqueous phase, b) oil-soluble and/or oil-miscible ingredients are mixed with oils at ambient or elevated temperatures to form an oil phase, and c) the aqueous phase and the oil phase are mixed together to form the compositions. Dispersion compositions may be prepared by forming an aqueous phase as described above and mixing in oil-soluble and/or oil-miscible ingredients at ambient or elevated temperatures.

The present composition may optionally include one or more moisturizers/emollients in addition to the high melting point wax. Such moisturizers/emollients include, but are not limited to, the following: propylene glycol, allantoin, acetamine MEA, oat protein and hyaluronic acid. Additional moisturizers/emollients are disclosed in column 9 of U.S. Pat. No. 4,883,659 and in column 4 of U.S. Pat. No. 5,162,378, which are incorporated herein by reference.

The present composition may optionally include one or more sunscreen agents. Sunscreen agents function to reduce or reflect the amount of ultra violet light (UVA and UVB) that strikes the skin or hair. Such agents may help retain a desired shade of colored hair, prevent sunburn or reduce photo aging of the skin. Useful sunscreen agents include, but are not limited to the following: benzophenone, octyl methylcinnamate, octyl salicylate, titanium dioxide, zinc oxide and combinations thereof. Other useful sunscreen agents are disclosed in columns 3 and 4 of U.S. Pat. No. 5,000,937, which are incorporated herein by reference.

The present composition may optionally include one or more vitamins. Oil and water soluble vitamins can be incorporated in oil and water phases, respectively. Useful vitamins include, but are not limited to, vitamin A in the form of retinol palmitate, vitamin B as panthenol, vitamin E as tocopheryl acetate, or any combinations thereof.

The present composition may optionally include one or more skin whiteners. Useful vitamins include, but are not limited to, magnesium ascorbyl phosphate, licorice extract, arbutin, kojic acid, grape seed extract, Mulberry root extract, hydroquinone, or any combinations thereof.

The present composition may optionally include one or more exfoliating agents. Exfoliating agents aid in the removal of dead skin cells. Useful exfoliating agents include, but are not limited to, walnut shell, pumice, polyethylene beads, salicylic acid, lactic acid, glycolic acid, trioxaundecanedioic acid, or any combinations thereof.

The present composition may optionally include one or more antimicrobial agents and/or preservatives. Useful antimicrobial agents and/or preservatives include, but are not limited to, triclosan, phenoxyethanol, benzoic acid, methylparaben, imidazolidine urea, or any combinations thereof.

The present composition is useful in cleansing the surface of skin, hair or nail. The composition is applied to an affected area of the surface and the surface washed/rinsed. The composition can be washed/rinsed away immediately, a few seconds later or a few minutes later. Although it is usually most desirable to wash/rinse the composition within a few minutes, it is within the scope of the method of the present invention to leave the composition for a longer period of time, i.e. hours or days, prior to washing/rinsing. Useful compositions include a shampoo, a hair conditioner, a body wash, a shaving cream, a shower cream, an exfoliating scrub, a liquid soap and a bubble bath.

Optionally, the present composition may include one or more of the following ingredients: humectants, skin conditioning agents, antifungals, antiallergenic agents, antiflammatory agents, antiseptics, chelating agents, colorants, film formers, fragrances, lubricants, skin protectants, and stabilizers.

The following is an example of the present invention. All percentages and parts are by weight unless otherwise noted.

### EXAMPLES

Compositions of the present invention were prepared as follows: a) water-soluble and/or water-miscible ingredients were mixed with water at ambient or elevated temperatures to form an aqueous phase, b) oil-soluble and/or oil-miscible ingredients were mixed with oils at ambient or elevated temperatures to form an oil phase, and c) the aqueous phase and the oil phase were mixed together to form the compositions.

### Example 1

| Ingredient | Percent range |
|---|---|
| Water | 20.0-80.0% |
| High melting point wax | 0.1-15.0% |
| Anionic surfactant | 5.0-50.0% |
| Nonionic surfactant | 1.0-15.0% |
| Amphoteric surfactant | 1.0-40.0% |
| Preservatives | 0.0-5.0% |
| Optional ingredients, | 0.1-30.0% |
| i.e. fragrances, | |
| colorants | |

### Example 2

| Ingredients | |
|---|---|
| Sodium Laureth Sulfate | 25.0 wt % |
| Cocamide MIPA | 6.0 wt % |
| Hydrogenated Castor Oil | 4.0 wt % |
| melting point 90° C. | |
| Preservatives | 0.5 wt % |
| Fragrances | 0.75 wt % |
| Emollient | 2.0 wt % |
| Water | QS |

### Example 3

| Ingredients | |
|---|---|
| Sodium Laureth Sulfate | 25.0 wt % |
| Cocamido Propyl Betaine | 6.0 wt % |
| Hydrogenated Castor Oil | 4.0 wt % |
| melting point 90° C. | |
| Preservatives | 0.5 wt % |
| Fragrances | 0.75 wt % |
| Emollient | 2.0 wt % |
| Water | QS |

### Example 4

| Ingredients | |
|---|---|
| Sodium Laureth Sulfate | 25.0 wt % |
| Cocamido Propyl Betaine | 6.0 wt % |
| Cocamide MIPA | 6.0 wt % |
| Hydrogenated Castor Oil | 4.0 wt % |
| melting point 90° C. | |
| Preservatives | 0.5 wt % |
| Fragrances | 0.75 wt % |
| Emollient | 2.0 wt % |
| Water | QS |

The composition was viscous, rich, elegant cream with excellent lathering and cleansing.

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

1. A topical aqueous cleansing composition, comprising:
about 0.05 wt % to about 20 wt % of one or more waxes having a melting point of about 70° C. or more;
an anionic surfactant and an additional surfactant selected from the group consisting of a nonionic surfactant, an amphoteric surfactant, and a combination of a nonionic surfactant and an amphoteric surfactant, in an amount effective to stabilize the wax in the composition; and
about 20 wt % or more water.

2. The composition of claim 1, wherein the one or more waxes has a melting point of about 80° C. to about 100° C.

3. The composition of claim 1, wherein the one or more waxes has a melting point of about 85° C. to about 90° C.

4. The composition of claim 1, wherein the one or more waxes has a hydrogenated oil with an iodine point of about 40 or less.

5. The composition of claim 1, wherein the one or more waxes is a hydrogenated oil with an iodine point of about 5 or less.

6. The composition of claim 1, wherein the one or more waxes is present at about 0.4 to about 10 wt %.

7. The composition of claim 1, wherein the one or more waxes is present at about 1 to about 5 wt %.

8. The composition of claim 1, wherein the one or more waxes is selected from the group consisting of hydrogenated castor oil wax, candelilla wax, carnauba wax, hydrogenated jojoba wax, beeswax, ozokerite, lanolin wax, montan wax, paraffin, palm kernel wax, ceresin, silicone waxes, cetyl esters, and any combinations thereof.

9. The composition of claim 1, wherein the one or more waxes has a hardness of about 4 or more.

10. The composition of claim 1, wherein the one or more waxes has a hardness of about 4 to about 14.

11. The composition of claim 1, wherein the composition has about 5 to about 50 wt % of one or more anionic surfactants, about 1 to about 15 wt % of one or more nonionic surfactants, and about 1 to about 40 wt % of one or more amphoteric surfactants.

12. The composition of claim 1, wherein the composition has about 15 to about 30 wt % of one or more anionic surfactants, about 5 to about 10 wt % of one or more nonionic surfactants, and about 5 to about 15 wt % of one or more amphoteric surfactants.

13. The composition of claim 1, wherein the water is present at about 20 wt % to about 90 wt %.

14. The composition of claim 1, wherein the water is present at about 40 wt % to about 80 wt %.

15. The composition of claim 1, wherein the water is present at about 60 wt % to about 80 wt %.

16. The composition of claim 1, wherein the viscosity of the composition is about 1,000 to about 40,000 cps.

17. The composition of claim 1, wherein the viscosity of the composition is about 10,000 to about 40,000 cps.

18. The composition of claim 1, wherein the viscosity of the composition is about 10,000 to about 30,000 cps.

19. The composition of claim 1, wherein the composition is in the form of a dispersion.

20. The composition of claim 1, wherein the composition is in the form of an emulsion.

21. The composition of claim 1, wherein the wax has a melting point of about 80° C. to about 100° C., wherein the wax is present from about 0.1 to about 10 wt %, wherein the composition has about 5 to about 50 wt % of one or more anionic surfactants, about 1 to about 15 wt % of one or more nonionic surfactants, and about 1 to about 40 wt % of one or more amphoteric surfactants, wherein the water is present at about 40 wt % to about 80 wt %, and wherein the composition has a viscosity of about 10,000 to about 40,000 cps.

22. The composition of claim 21, wherein the composition is in the form of a dispersion.

23. The composition of claim 21, wherein the composition is in the form of an emulsion.

24. The composition of claim 1, wherein the wax has a melting point of about 85° C. to about 90° C., wherein the wax is present from about 0.4 to about 4.0 wt %, wherein the composition has about 15 to about 30 wt % of one or more anionic surfactants, about 5 to about 10 wt % of one or more nonionic surfactants, and about 5 to about 15 wt % of one or more amphoteric surfactants, and wherein the water is present at about 60 wt % to about 80 wt %, and wherein the composition has a viscosity of about 10,000 to about 30,000 cps.

25. The composition of claim 24, wherein the composition is in the form of a dispersion.

26. The composition of claim 24, wherein the composition is in the form of an emulsion.

27. The composition of claim 1, wherein the composition is substantially free of thickeners or viscosifiers other than the high melting point wax.

28. A method of cleansing a keratinous surface, comprising applying to the surface the composition of claim 1 and then rinsing the surface.

29. A method of moisturizing a keratinous surface, comprising applying to the surface the composition of claim 1 and then rinsing the surface.
